(19) United States
(12) Patent Application Publication
(10) Pub. No.: US 2006/0041520 A1
(43) Pub. Date: Feb. 23, 2006

(54) Business process for the plantation and beneficiation of vegetation

(76) Inventor: Sebastien Leonard, Montreal (CA)

Correspondence Address: VENABLE LLP, P.O. BOX 34385, WASHINGTON, DC, 20045-9998, US

(21) Appl. No.: 11/204,376

(22) Filed: Aug. 16, 2005

(30) Foreign Application Priority Data
Aug. 17, 2004 (CA) 2,478,791

(51) Int. Cl. G06F 17/00

(52) U.S. Cl. 705/500

(57) ABSTRACT

A business process for the installation and beneficiation of vegetation according to the present invention comprises a first party having rights related to vegetation, such as trees, installing the trees on a site owned by a second party; and the second party assigning rights to the first party to use the tree to display information such as publicity for a limited period of time. At the beginning or end of the limited period of time, the first party assigns all rights related to the vegetation to the second party. The present process offers many advantages for the environment, to the population and to the economy.

### CROSS-REFERENCE TO RELATED APPLICATION

This application claims the priority of Canadian Patent Application No. 2,478,791 filed Aug. 17, 2004, the subject matter of which is incorporated herein by reference.

### FIELD OF THE INVENTION

The present invention relates to landscaping. More specifically, the present invention is concerned with a business process for the plantation and beneficiation of vegetation.

### BACKGROUND OF THE INVENTION

The ever increasing urbanisation results in the augmentation of two unrelated phenomenon: the pollution and the opportunities for publicity.

First of all, the increase of the population in addition to the urbanisation phenomenon brings more people to the city, which yields less and less room for manoeuvre to governments and mayors to come up with so-called green solutions to their urbanisation development considering the taxes burden. The limited sources of income most often have to be allotted to more urgent matters than environment issues.

On the other hand, advertisements are more than ever invading our every day field of view with the detriment of the vegetation. The advertiser wants the attention of the customer without rewarding him in any means. It results that the customer seems to loose on all sides in this increasing marketing war.

Solutions to these problems are thus desirable.

### OBJECTS OF THE INVENTION

An object of the present invention is therefore to provide a greener advertisement process.

Another object of the invention is to provide a business process for the installation and the beneficiation of vegetation.

### SUMMARY OF THE INVENTION

More specifically, in accordance with a first aspect of the present invention, there is provided a business process for the installation and beneficiation of vegetation comprising: a first party providing a property owned by a second party with vegetation; and the second party assigning rights to the first party to use the vegetation to display information for a limited period of time.

According to a second aspect of the present invention, there is provided a business process for the installation and beneficiation of vegetation comprising: a first party having rights related to a first quantity of vegetation installing the first quantity of vegetation on a site owned by a second party; and the second party assigning rights to the first party to use the first quantity of vegetation to display information for a limited period of time.

According to a specific embodiment, the above process further comprises subdividing the limited period of time in at least one interval of time; at the end of at least one of the at least one interval of time, the first party installing a second quantity of vegetation on the site owned by said second party.

According to more specific embodiments of the above process, the first party reassigns the rights related to the vegetation to the second party at the beginning or after the limited period of time.

A business process for the installation and beneficiation of vegetation according to the present invention offers many advantages for the environment including:
carbon dioxide reduction by increasing the amount of vegetation;
incentive to plant trees along roads and city streets, which in is known to reduce the level of both dust and noise cause by traffic; the presence of trees near parking lots is also known to reduce the temperature by creating shadows; and
the increasing presence of vegetation lowering both erosion and water pollution.

The present process offers many advantages for the population including:
the environment is embellished by the vegetation;
air in a “greener zone” is beneficial for the human respiratory and circulatory systems; and
the vegetation and more specifically trees diminishing bad odors by absorbing pollutant;
and for the economy:
vegetation and more specifically trees purify the atmosphere;
well-kept vegetation increases the value of a residential or of a commercial property; in case of a municipality, it is well-known that the abundance of vegetation contributes to attracting new residents;
rows of trees strategically positioned help prevent snow accumulation on roads, which allows diminishing the cost of road maintenance; and
trees may contribute protecting buildings against wind and snow, which help lowering the heating cost.

Compare to other medium of communication, a process for the installation and beneficiation of vegetation according to the present invention provides a means to recognize the attention given by the customers to advertisements and to any forms of solicitations in general by returning some direct values to the customers in the form of vegetation or of any improvement of his immediate environment with all the above-mentioned advantages in exchange for some of their attention. As such, a process according to the present invention provides to the advertisers means for retributing the customers.

Moreover, a business process according to the present invention provides means to funding environment and economic development. It also promotes local development by helping creating jobs including: entrepreneurs, botanists, horticulturists, truckers, constructions workers, carpenters, etc.

A business process according to the present invention yields a new marketing tool. Indeed, by monitoring the number of people accessing or passing by the property or site owned by the second party, one may give a commercial value to the display of information by the first party using the vegetation.

According to a third aspect of the present invention, there is provided a display for advertising a third party from a predetermined location owned by a first party, the display comprising: a first display area for displaying information about the first party; a second display area for displaying information about the third party; and a third display area for displaying relative direction from the predetermined location to a third party location.

The display according to the present invention is advantageous since it provides a “signing” effect in addition to an advertisement/informational function.

According to a fourth aspect of the present invention, there is provided a business process for the installation and beneficiation of vegetation comprising: a first party having rights related to a first quantity of vegetation installing the first quantity of vegetation on a site owned by a second party; and the second party assigning rights to the first party to display information for a limited period of time on the site owned by the second party or on another site owned by the second party.

Other objects, advantages and features of the present invention will become more apparent upon reading the following non restrictive description of preferred embodiments thereof, given by way of example only with reference to the accompanying drawings.

### BRIEF DESCRIPTION OF THE DRAWINGS

In the appended drawings:

FIG. 1 is flowchart illustrating a business process for the installation and beneficiation of vegetation according to an illustrative embodiment of a first aspect of the present invention;

FIG. 2 is a perspective view illustrating a central boulevard including advertisement displays according to a first illustrative embodiment of a second aspect of the present invention;

FIG. 2B is a top plan view of the advertisement display from FIG. 2;

FIG. 3 is a perspective view illustrating a central boulevard including the advertisement displays from FIGS. 2B and 3, illustrated secured adjacent a respective tree using alternative mounting means;

FIG. 4 is a perspective view illustrating a public building including advertisement displays according to a second illustrative embodiment of the second aspect of the present invention; and

FIG. 5 is a flowchart illustrating a business process for the installation and beneficiation of vegetation according to a second illustrative embodiment of the first aspect of the present invention.

### DETAILED DESCRIPTION

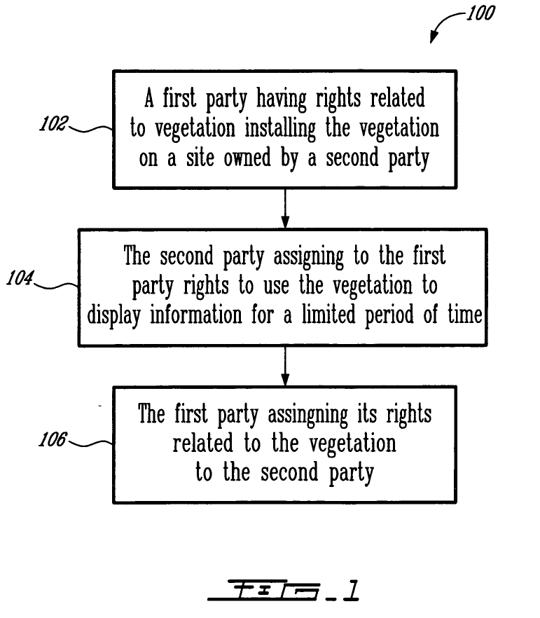

A business process 100 for the installation and beneficiation of vegetation according to a first illustrative embodiment of the present invention will be described with reference to FIG. 1 of the appended drawings.

The process 100 comprises the following general steps:
102—a first party having rights related to vegetation installing the vegetation on a site owned by a second party;
104—the second party assigning rights to the first party to use the vegetation to display information for a limited period of time; and
106—the first party assigning its rights related to the vegetation.

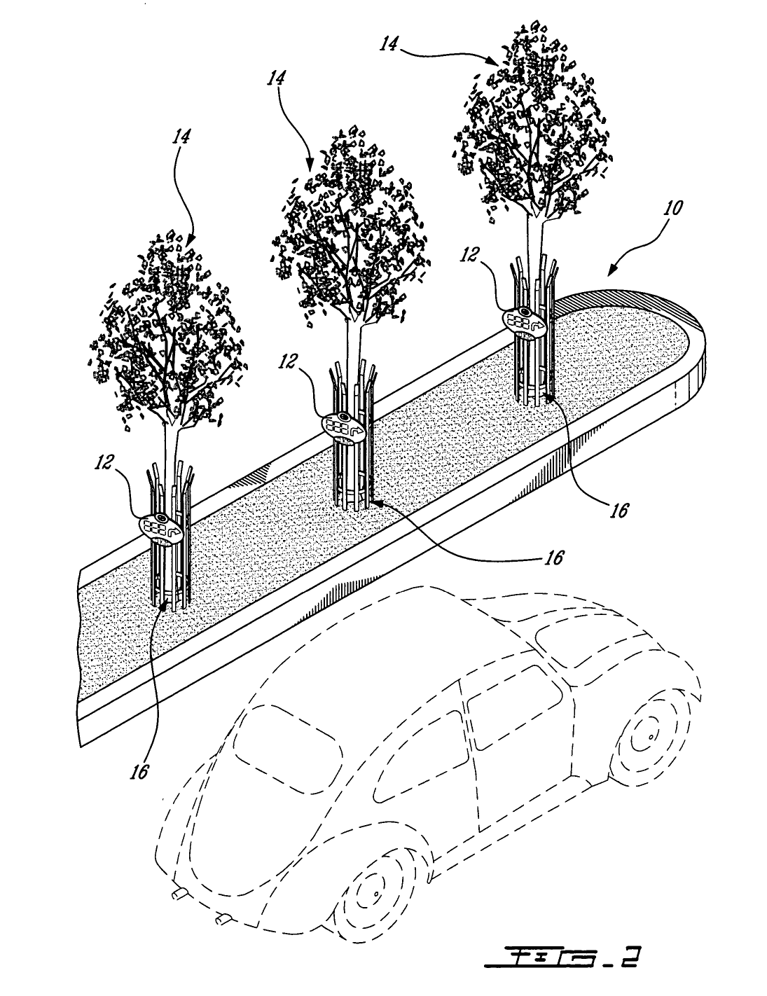

The process 100 will now be exemplified first with reference to FIG. 2, illustrating a central boulevard 10 including advertisement displays 12 according to a first illustrative embodiment of the present invention.

According to this example, and referring also to FIG. 1, a first party buys trees 14 and offers a second party, being a municipality, to plant these trees for free on city land, such as the central boulevard 10 illustrated in FIG. 2. This corresponds to step 102 from method 100.

It is foreseen, for example by legal contract, that the municipality assigns to the first party rights to display information on the trees 14 for a limited period of time, such as for example, two years (see step 104 from FIG. 1). Of course, the limited period of time can be set to another value.

During the limited period of time, the first party is allowed to commercially exploit the trees 14, for example by using the trees 14 to display advertisement using advertisement display 12.

At the end of the limited period of time, the first party alienates all commercial rights relative to the trees 14 to the municipality, property rights having been lost at the beginning of the limited period of time (step 106).

Even though, in step 106, the first party gives the vegetation to the second party at the beginning of the predetermined period of time, it may be foreseen, for example by contract, that the first party warranties the survival or even the maintenance of the vegetation during the limited period of time or during a different period of time.

According to another embodiment of the process 100, the first party alienates all rights relative to the vegetation only at the end of the limited period of time.

Even though step 102 refers to the first party having rights relative to and installing vegetation, the present invention is not limited thereto. For example, as illustrated in FIG. 2, the rights may also extend to any structure, such as the tree protective-screen 16 which can be provided with vegetation. At the end of the period of time, it can be foreseen by contract that the first party only assigns either rights related to the vegetation or both the rights related to the vegetation and to the structure 16.

Costs involved in the plantation of the trees 14 can either be at the charge of the first or second party. This can be determined and foreseen by contract.

In step 104, the rights to use the trees 14 to display information can be assigned exclusively or not to the first party without departing from the spirit and nature of the present invention. The exclusive rights can be limited for a predetermined territory.

Even though, the advertisement display 12 are illustrated in FIG. 2, secured at every tree 14 through the protective screen 16, one can adapt the process 100 so as to provide only some of the trees 14 with an advertisement display 12.

Turning now to FIG. 2B, one of the advertisement displays 12 will now be described in more detail.

The display 12 is generally oval shaped and comprised of a first display area 18 for displaying information about the first party from a predetermined location, a second display area 20 for displaying information about a third party, a third display area 22 for displaying relative direction from the predetermined location to a third party location (not shown), and a fourth display area 24 for displaying information indicative of a relative distance between the predetermined location and the third party location.

The first display area 18 may comprise for example the coat of arms of the municipality, or of the province. It may also include a logo or a name for example.

The second display area 20 may comprise any written information about a third party, including numbers, logo, words, and any combination thereof. It is to be noted that the third party can also be the first or second party. Indeed, for example, a society may wish to offer to plant tree to a municipality in exchange to rights to use the trees to advertise its own services or products.

The third display area 22 includes information pertaining to the direction from the predetermined location where the advertisement display 12 is to be displayed to a location pertaining to the third party advertised in the second area 20.

The general configuration and shape of the advertisement display 12 may of course vary. The advertisement display may be made of any material including wood, plastic and metal with inscriptions painted thereon. The advertisement display can also be an electronic display including a display screen. In this particular case, means can be provided to remotely update information on the display 12. Such means may include a controller (not shown), a memory coupled to the controller (not shown), and a radio, wi-fi or other type of receiver (not shown) also coupled to the controller. An electronic display according to the present invention can also be provided with input means so as to be updatable on-site. Since, controllers, memories and receivers are believed to be well-known in the art; they will not be described herein in more detail.

According to a further illustrative embodiment of the present invention, the advertisement displays are in the form of advertisement panels displaying information about the sponsor or sponsors of the installation of the vegetation.

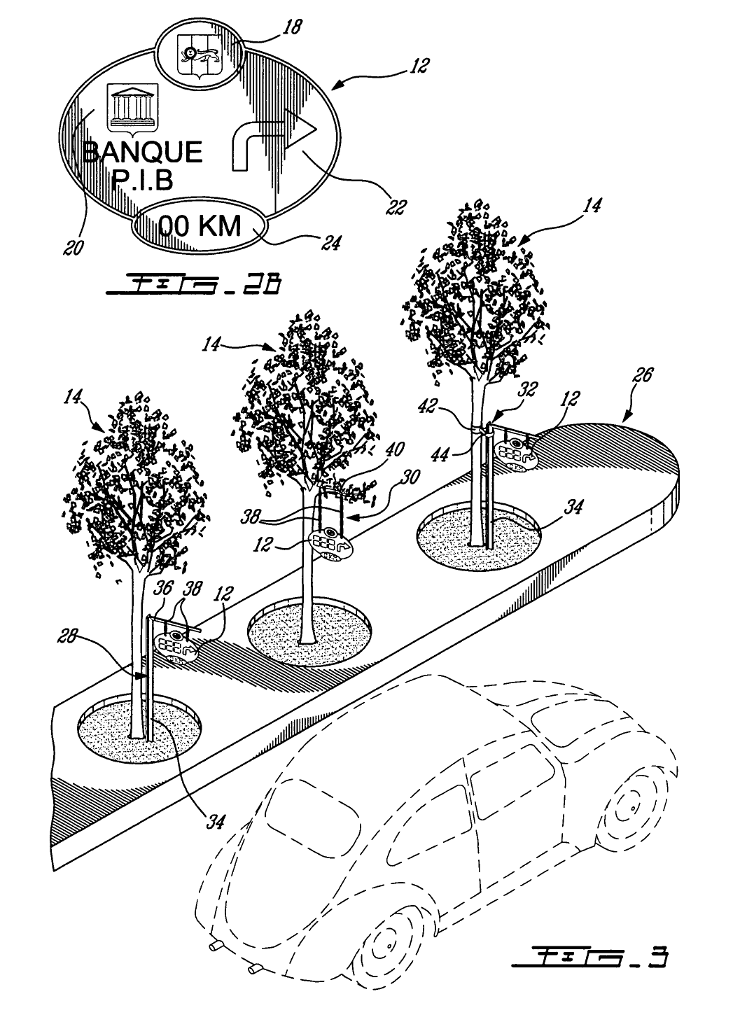

FIG. 3 illustrates a central boulevard 26 including advertisement displays 12, positioned next to respective trees using three different mounting means 28-32 which will now be briefly described.

The first advertisement display mounting means 28 is in the form of a typical reversed L-shaped structure comprised of a pole or peg 34 set in the ground next to the tree 14 and of a rod 36 extending perpendicularly at the top longitudinal end thereof. The mounting means 28 further includes two chains 38 or the likes for hanging the display 12. Of course, in other embodiments, the display 12 may hang directly from the rod 36. In both cases, the display is provided with apertures for receiving the chains 38 or the likes.

The second advertisement display mounting means 30 is in the form of two hanging means in the form of chains 38 of the likes for hanging the display 12 to a branch 40 of the tree 14. Of course, the number of hanging means may vary. Other possible hanging means may include ropes, wires, straps, etc., made of any sufficiently rigid materials including nylon, metal, leather, etc.

Since the third advertisement display mounting means 32 is very similar to the first one 28, only the differences will be described herein in more detail. The mounting means 32 further includes an adjustable band 42 mounting about the trunk of the tree 14 and a strap 44 secured thereto for mounting on the pole 34, the ensemble band 42, strap 44 and pole 34 acting as a tutor for the tree 14.

Of course, for reason of uniformity and look, one might choose to position the advertisement displays 12 using similar mounting means.

Even though the present invention has been described by way of examples wherein the site is a central boulevard 10 or 26, the process 100 can be implemented on other sites, including exterior sites and interior sites.

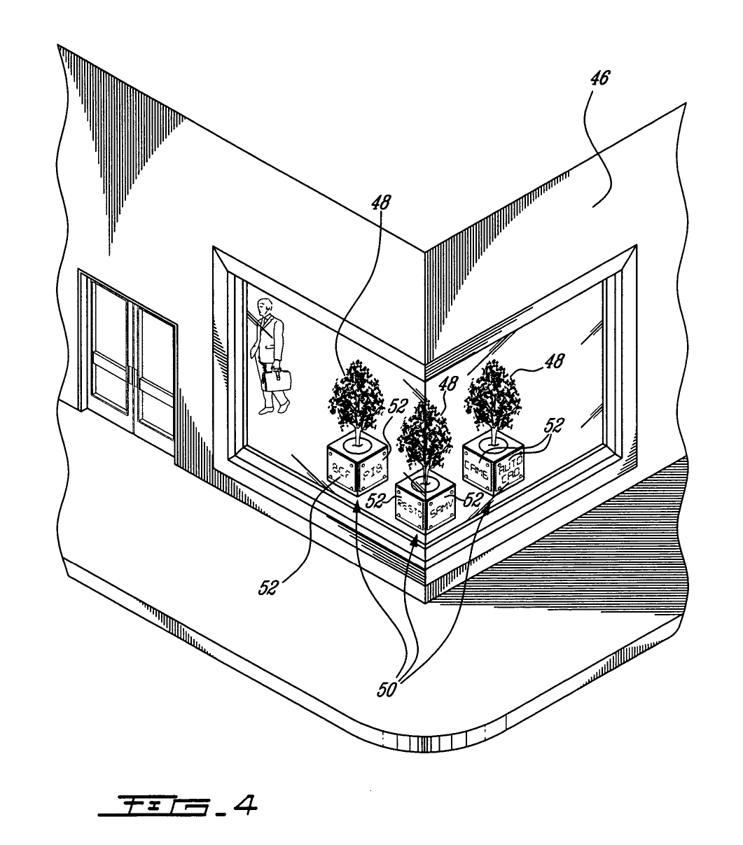

For example, as illustrated in FIG. 4, the first party having rights related to vegetation can install such vegetation in a public or private building 46.

According to the illustrative embodiment of FIG. 4, the vegetation is in the form of small trees or plants 48 in massive cubic flower containers 50 provided with removable plates 52 on their side faces. The plates 52 allow displaying information and therefore acting as information/advertisement displays.

Returning to FIG. 1 and referring to the example of FIG. 4, a first party pays to install a predetermined number of flower containers 50 in the building 46, which is owned by a second party (step 102).

The second party allows the first party to display advertisements onto the flower boxes 50 for a limited period of time (step 104). The fact that the plates 52 are made removable allows the first party more flexibility in its advertisement campaign.

At the end of the limited period of time, the first party gives all the small trees 48 with the containers 50.

According to a further illustrative example of implementation of the process 100, a first party plants trees along highways on lands owned by a government (step 102). The government assigns to the first party commercial rights related to the trees for a limited period of time (step 104). The first party assigns its rights related to the trees to the government at the end of the limited period of time (step 106).

According to a further embodiment of the process 100, the first party assigns all its rights relative to the vegetation upon installation or plantation thereof, steps 106 becoming useless.

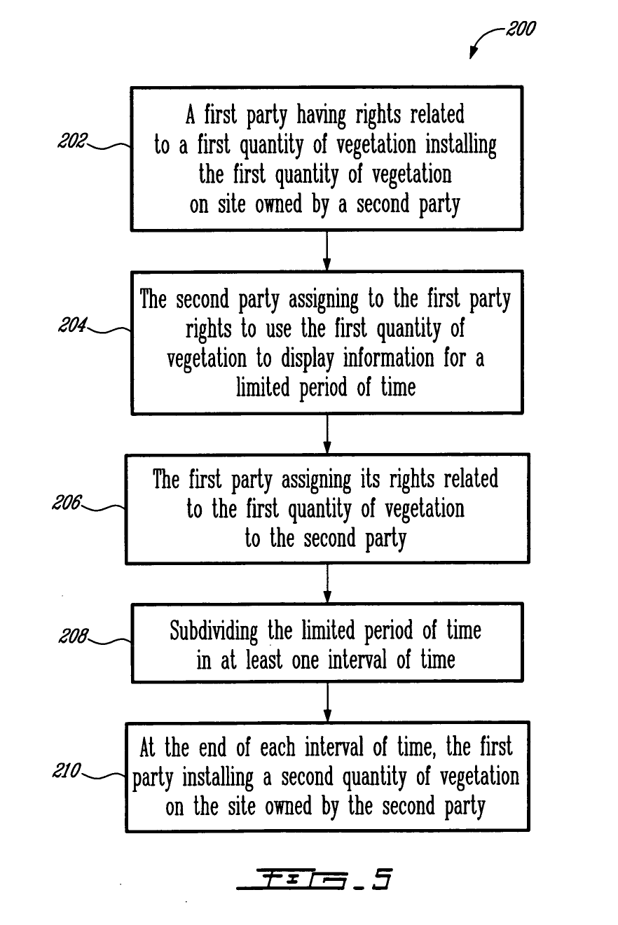

A business process 200 for the installation and beneficiation of vegetation according to a second illustrative embodiment of the present invention will now be described with reference to FIG. 5 of the appended drawings.

The process 200 comprises the following general steps:
202—A first party having rights related to a first quantity of vegetation installing the first quantity of vegetation on a site owned by a second party;
204—The second party assigning to the first party rights to use the first quantity of vegetation to display information for a limited period of time;
206—The first party assigning its rights related to the first quantity of vegetation to the second party at the beginning of the limited period of time;
208—Subdividing the limited period of time in at least one interval of time; and
210—At the end of each interval of time, the first party installing a second quantity of vegetation on the site owned by the second party.

The process 200 will now be described in more detail with reference to a specific example of application. According to this application, a first party plants thirty (30) trees for a municipality for free at a predetermined site (step 202). The municipality assigns to the first party rights to display advertisements using the thirty trees for a period of 3 years (step 204). At step 206, the first party assigns its rights related to the first quantity of trees to the second party at the beginning of the 3 years period. At the end of each year (steps 208-210), the first party agrees to plant sixty (60) additional trees at the site without having the rights to use them for display.

As will now become more apparent, a structure can be installed with the vegetation and be left to the second party at the end of the limited period of time. Such structure can take many forms, including without limitations pots, tutors, containers, panels, supports, sidewalks, etc.

Even though the present invention has been described by way of reference to specific embodiments referring to the site in step 102 as being a central boulevard, or a public building, the site can of course take many other forms, including without limitations an outside or inside playground, a private or public land, a traffic lane, a mall, a store, a restaurant, etc.

Of course, the expression “site” is also to be construed herein broadly. For example, according to the present process, the expression “site” should be construed as meaning a city, a highway, a park, a series of consecutive or non-consecutive central boulevards, etc.

The expression vegetation should also be construed herein broadly so as to include, for example, in addition to trees, grass, shrubs, plants in a pot or not, flowers, etc., and also artificial embodiments thereof, including plastic and paper flowers and plants.

Even though the process according to the present invention has been described by way of example referring to advertisement display, other type of information can also be displayed on the vegetation including without limitations proposal, directional information display, trademarks, navigational information, delineation, announcement of any kind, regulation, political or other kind of solicitation, etc.

In cases where display panels or any other structure that can be positioned remotely from the vegetation are used to display information in steps 104 and 204 of processes 100 and 200 respectively, such structure can indeed be positioned at a distance from the vegetation that is installed in step 102 or 202.

Although the present invention has been described hereinabove by way of preferred embodiments thereof, it can be modified without departing from the spirit and nature of the subject invention, as defined in the appended claims.

What is claimed is:

1. A business process for the installation and beneficiation of vegetation comprising:
a first party providing a property owned by a second party with at least vegetation; and
said second party assigning rights to said first party to use said at least vegetation to display information for a limited period of time.

2. A business process as recited in claim 1, wherein said second party assigning rights to said first party to use said at least vegetation to display information through a legal contract.

3. A business process as recited in claim 1, wherein said rights are exclusive rights.

4. A business process as recited in claim 3, wherein said exclusive rights are limited for a predetermined territory.

5. A business process as recited in claim 1, wherein said at least vegetation includes a structure.

6. A business process as recited in claim 5, wherein said structure is selected from the group consisting of a tree-protective screen, a flower or plant container, a pot, a panel, a support, a sidewalk, and a tutor.

7. A process as recited in claim 6, wherein said plant container is provided with at least one removable plate on one of its side faces; said at least one removable plate being used to display information.

8. A business process as recited in claim 1, wherein said at least vegetation includes at least one of a tree, a plant, grass, shrubs, and artificial vegetation.

9. A business process as recited in claim 1, wherein said property is selected from the group consisting of a city, a city land, a central boulevard, lands along a highway, a public or private building, a traffic lane, a mall, a store, a restaurant, a commerce, and a park.

10. A business process as recited in claim 1, wherein said property is exterior or interior.

11. A business process as recited in claim 1, wherein said second party is selected from the group consisting of a municipally, a government, and an individual.

12. A business process as recited in claim 1, wherein said information includes at least one of advertisement, proposal, directional information, trademarks, navigational information, delineation, announcement, regulation, information about at least one sponsor of said at least vegetation and political solicitation.

13. A business process for the installation and beneficiation of vegetation comprising:
a first party having rights related to a first quantity of vegetation installing said first quantity of vegetation on a site owned by a second party; and
said second party assigning rights to said first party to use said first quantity of vegetation to display information for a limited period of time.

14. A process as recited in claim 13, wherein said first party further installing a structure on said site and said second party further assigning rights to said first party to use said structure in addition to said vegetation to display information for said limited period of time.

15. A process as recited in claim 14, wherein said structure is selected from the group consisting of a tree-protective screen, a flower or plant container, a pot, a panel, a support, a sidewalk, and a tutor.

16. A process as recited in claim 15, wherein said plant container is provided with at least one removable plate on one of its side faces; said at least one removable plate being used to display information.

17. A process as recited in claim 13, wherein said second party assigning rights to said first party to use said vegetation to display information through a legal contract.

18. A business process as recited in claim 13, wherein said rights are exclusive rights.

19. A process as recited in claim 18, wherein said exclusive rights are limited for a predetermined territory.

20. A process as recited in claim 13, further comprising subdividing said limited period of time in at least one interval of time; at the end of at least one of said at least one interval of time, said first party installing a second quantity of vegetation on said site owned by said second party.

21. A process as recited in claim 20, wherein said second quantity of vegetation is an integer multiple of said first quantity of vegetation.

22. A process as recited in claim 13, further comprising said first party assigning said rights related to the vegetation to the second party at the end of said limited period of time.

23. A process as recited in claim 13, further comprising said first party assigning said rights related to the vegetation to the second party at the beginning of said limited period of time.

24. A process as recited in claim 13, wherein said vegetation includes at least one of a tree, a plant, grass, shrubs, and artificial vegetation.

25. A process as recited in claim 13, wherein said site is selected from the group consisting of a city, a city land, a central boulevard, lands along a highway, a public or private building, a traffic lane, a mall, a store, a restaurant, a commerce, and a park.

26. A process as recited in claim 13, wherein said site is exterior or interior.

27. A process as recited in claim 13, wherein said second party is selected from the group consisting of a municipally, a government, and an individual.

28. A process as recited in claim 13, wherein said information includes at least one of advertisement, proposal, directional information, trademarks, navigational information, delineation, announcement, regulation, information about at least one sponsor about said first quantity of vegetation and political solicitation.

29. A display for advertising a third party from a predetermined location owned by a first party, the display comprising:
a first display area for displaying information about the first party;
a second display area for displaying information about the third party; and
a third display area for displaying relative direction from the predetermined location to a third party location.

30. A display as recited in claim 29, further comprising a fourth display area for displaying information indicative of a relative distance between the predetermined location and said third party location.

31. A display as recited in claim 29, wherein said third party and one of said first and second party is the same.

32. A display as recited in claim 29, wherein said first display area includes at least one of a logo, a name and a coat of arm.

33. A display as recited in claim 29, wherein said second display area includes at least one of a number, a logo, and a word.

34. A display as recited in claim 29, wherein said display is made of at least one of wood, plastic and metal.

35. A display as recited in claim 29, wherein said display includes an electronic display.

36. A display as recited in claim 35, further comprising means to remotely update information thereon.

37. A business process for the installation and beneficiation of vegetation comprising:
a first party having rights related to a first quantity of vegetation installing said first quantity of vegetation on a site owned by a second party; and
said second party assigning rights to said first party to display information for a limited period of time on said site owned by said second party or on another site owned by said second party.
